(19) United States
(12) Patent Application Publication
(10) Pub. No.: US 2017/0300336 A1
(43) Pub. Date: Oct. 19, 2017

(54) FPSCR STICKY BIT HANDLING FOR OUT OF ORDER INSTRUCTION EXECUTION

(71) Applicant: International Business Machines Corporation, Armonk, NY (US)

(72) Inventors: BRIAN D. BARRICK, PFLUGERVILLE, TX (US); STEVEN J. BATTLE, AUSTIN, TX (US); SUSAN E. EISEN, ROUND ROCK, TX (US); MICHAEL J. GENDEN, AUSTIN, TX (US); GLENN O. KINCAID, AUSTIN, TX (US); DUNG Q. NGUYEN, AUSTIN, TX (US); BRIAN W. THOMPTO, AUSTIN, TX (US); KENNETH L. WARD, AUSTIN, TX (US)

(21) Appl. No.: 15/131,502

(22) Filed: Apr. 18, 2016

(51) Int. Cl. G06F 9/38; G06F 9/30

(52) U.S. Cl. CPC G06F 9/3836; G06F 9/30101

(57) ABSTRACT

A hardware execution unit within a processor core executes a second instruction, which is part of a software thread, and which is executed out of order within the software thread. A sticky bit flip detection hardware device detects a change to a sticky bit in a floating-point status and control register (FPSCR) within the processor core. An instruction issue hardware unit identifies a first instruction that is in the software thread that is capable of reading or clearing the sticky bit. A flushing execution unit flushes all results of instructions from an instruction completion table (ICT) that include and are after the first instruction in the software thread. A hardware dispatch device dispatches all instructions that include and are after the first instruction in the software thread for execution by one or more hardware execution units within the processor core in a next-to-complete (NTC) sequential order.

### BACKGROUND

The present disclosure relates to the field of processors, and more specifically to the field of processor cores. Still more specifically, the present disclosure relates to the use of status and control registers when executing instructions out of order within a processor core.

### SUMMARY

In an embodiment of the present invention, a method and/or computer program product manages sticky bits within a floating-point status and control register (FPSCR) when instructions within a software thread are executed out of order within a processor core. A hardware execution unit within a processor core executes a second instruction, which is part of a software thread, and which is executed out of order within the software thread. A sticky bit flip detection hardware device detects a change to a sticky bit in a floating-point status and control register (FPSCR) within the processor core. A sticky bit is an exception bit that describes an exception that has occurred while executing an instruction within the processor core, and a sticky bit remains fixed until cleared by a move-to-FPSCR instruction, in which data is moved to the FPSCR, thus clearing the sticky bits. An instruction issue hardware unit identifies a first instruction that is in the software thread and that is capable of reading or clearing a sticky bit, where the first instruction is sequentially listed before any other instruction in the software thread that is capable of reading or clearing a sticky bit. In response to the instruction issue hardware unit identifying the first instruction, a flushing execution unit flushes all results of instructions from an instruction completion table (ICT) that include and are after the first instruction in the software thread. In response to the flushing execution unit flushing all results of instructions from the ICT that include and are after the first instruction in the software thread, dispatching, by a hardware dispatch device, all instructions that include and are after the first instruction in the software thread, and that are capable of reading or clearing a sticky bit, for execution by one or more hardware execution units within the processor core in a next-to-complete (NTC) sequential order.

In an embodiment of the present invention, a processor core includes: a hardware execution unit, where the hardware execution unit executes a second instruction, where the second instruction is part of a software thread, and where the second instruction is executed out of order within the software thread; a sticky bit flip detection hardware device that detects a change to a sticky bit in a floating-point status and control register (FPSCR) within the processor core, where the sticky bit is an exception bit that describes an exception that has occurred while executing an instruction within the processor core, and where the sticky bit remains fixed until cleared by a move-to-FPSCR instruction; an instruction issue hardware unit that identifies a first instruction in the software thread that is in an issue queue and that is capable of reading or clearing a sticky bit, where the first instruction is sequentially listed before any other instruction in the software thread that is capable of reading or clearing a sticky bit; a flushing execution unit that, in response to the first instruction being identified in the issue queue, flushes all results of instructions from an instruction completion table (ICT) that include and are after the first instruction in the software thread; and a hardware dispatch unit that, in response to the flushing execution unit flushing all results of instructions from the ICT that include and are after the first instruction in the software thread, dispatches all instructions including and after the first instruction in the software thread, that are capable of reading or clearing a sticky bit, for execution by one or more hardware execution units within the processor core in a next-to-complete (NTC) sequential order.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an exemplary computer system and/or network which may be utilized by the present invention;

FIG. 2 illustrates a table showing the impact on sticky bits within a floating-point status and control register (FPSCR) in a processor core when instructions within a software thread are executed in a next-to-complete (NTC) serial manner;

FIG. 3 depicts a table showing the impact on sticky bits within an FPSCR in a processor core when instructions within a software thread are executed in a out of order (OOO) non-serial manner;

FIG. 4 illustrates components within a processor core that enable the management of sticky bits within an FPSCR when instructions within a software thread are executed out of order within the processor core; and

FIG. 5 is a high-level flow chart of exemplary steps taken by hardware devices to manage sticky bits within an FPSCR when instructions within a software thread are executed out of order within a processor core.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

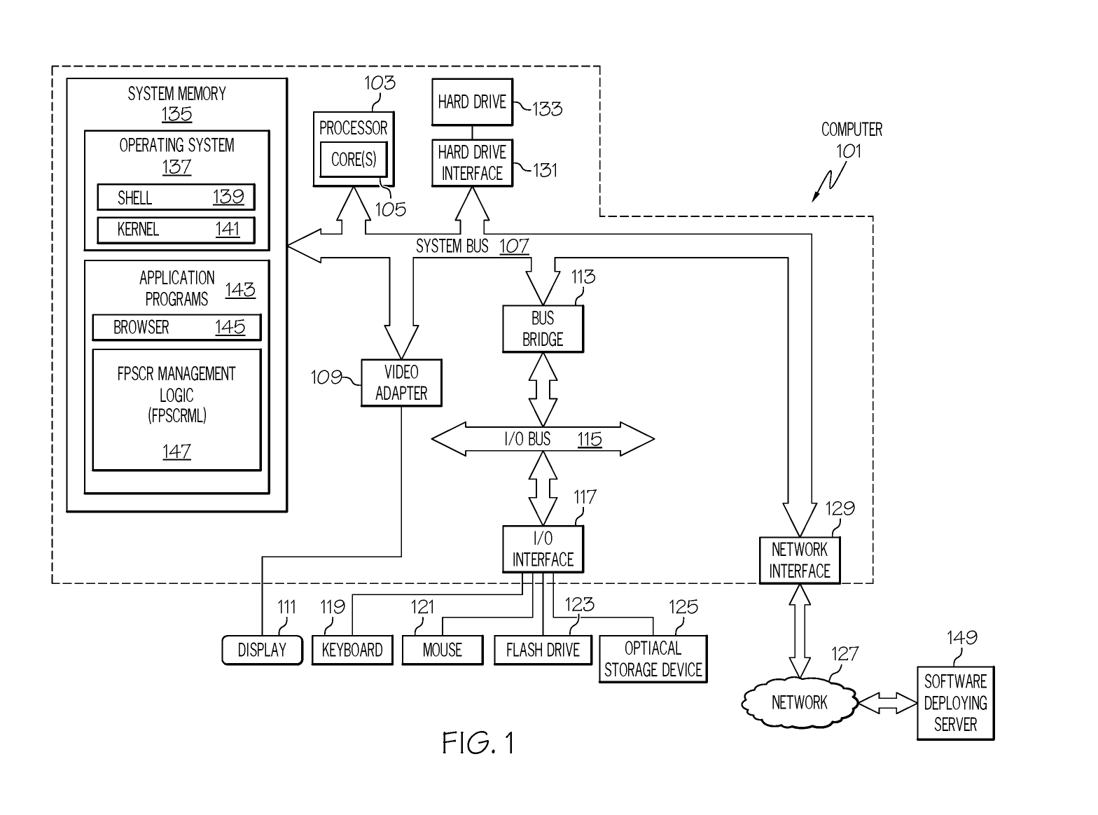

With reference now to the figures, and particularly to FIG. 1, there is depicted a block diagram of an exemplary computer 101, within which the present invention may be utilized. Note that some or all of the exemplary architecture shown for computer 101 may be utilized by software deploying server 149 shown in FIG. 1.

Computer 101 includes a processor 103, which may utilize one or more processors each having one or more processor cores 105. Processor 103 is coupled to a system bus 107. A video adapter 109, which drives/supports a display 111, is also coupled to system bus 107. System bus 107 is coupled via a bus bridge 113 to an Input/Output (I/O) bus 115. An I/O interface 117 is coupled to I/O bus 115. I/O interface 117 affords communication with various I/O devices, including a keyboard 119, a mouse 121, a Flash Drive 123, and an optical storage device 125 (e.g., a CD or DVD drive). The format of the ports connected to I/O interface 117 may be any known to those skilled in the art of computer architecture, including but not limited to Universal Serial Bus (USB) ports.

Computer 101 is able to communicate with a software deploying server 149 and other devices via network 127 using a network interface 129, which is coupled to system bus 107. Network 127 may be an external network such as the Internet, or an internal network such as an Ethernet or a Virtual Private Network (VPN). Network 127 may be a wired or wireless network, including but not limited to cellular networks, Wi-Fi networks, hardwired networks, etc.

A hard drive interface 131 is also coupled to system bus 107. Hard drive interface 131 interfaces with a hard drive 133. In a preferred embodiment, hard drive 133 populates a system memory 135, which is also coupled to system bus 107. System memory is defined as a lowest level of volatile memory in computer 101. This volatile memory includes additional higher levels of volatile memory (not shown), including, but not limited to, cache memory, registers and buffers. Data that populates system memory 135 includes computer 101's operating system (OS) 137 and application programs 143.

OS 137 includes a shell 139, for providing transparent user access to resources such as application programs 143. Generally, shell 139 is a program that provides an interpreter and an interface between the user and the operating system. More specifically, shell 139 executes commands that are entered into a command line user interface or from a file. Thus, shell 139, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 141) for processing. Note that while shell 139 is a text-based, line-oriented user interface, the present invention will equally well support other user interface modes, such as graphical, voice, gestural, etc.

As depicted, OS 137 also includes kernel 141, which includes lower levels of functionality for OS 137, including providing essential services required by other parts of OS 137 and application programs 143, including memory management, process and task management, disk management, and mouse and keyboard management.

Application programs 143 include a renderer, shown in exemplary manner as a browser 145. Browser 145 includes program modules and instructions enabling a World Wide Web (WWW) client (i.e., computer 101) to send and receive network messages to the Internet using HyperText Transfer Protocol (HTTP) messaging, thus enabling communication with software deploying server 149 and other described computer systems.

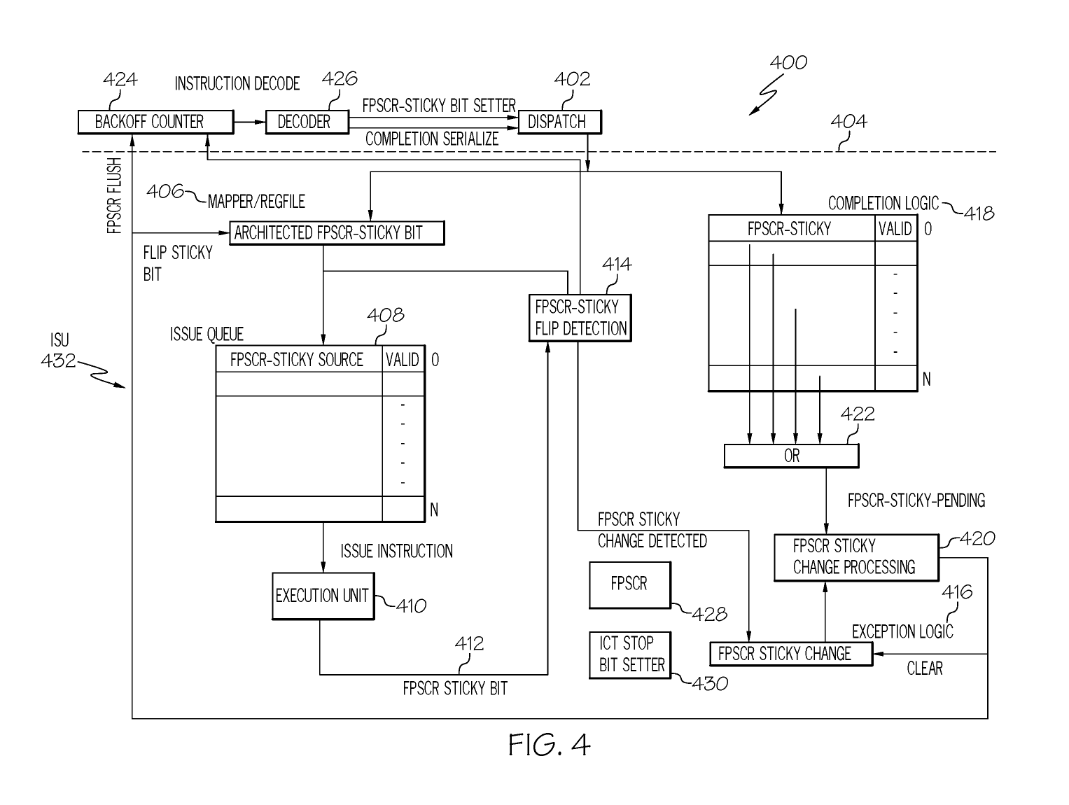

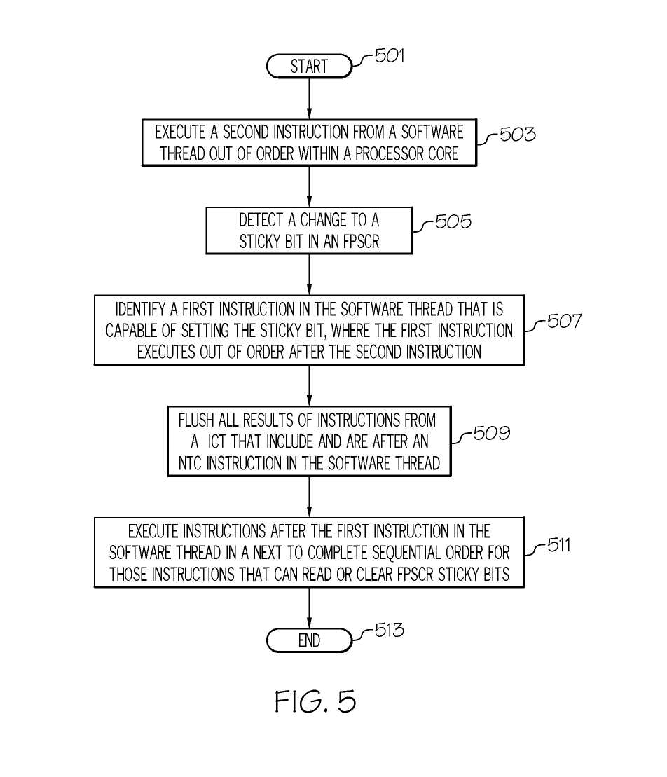

Application programs 143 in computer 101's system memory (as well as software deploying server 149's system memory) also include a Floating Point Status and Control Register Management Logic (FPSCRML) 147. FPSCRML 147 includes code for implementing the processes described below in FIGS. 4-5. In one embodiment, computer 101 is able to download FPSCRML 147 from software deploying server 149, including in an on-demand basis.

The hardware elements depicted in computer 101 are not intended to be exhaustive, but rather are representative to highlight essential components required by the present invention. For instance, computer 102 may include alternate memory storage devices such as magnetic cassettes, Digital Versatile Disks (DVDs), Bernoulli cartridges, and the like. These and other variations are intended to be within the spirit and scope of the present invention.

A Floating Point Status and Control Register (FPSCR) is a register within a processor core that contains exception bits indicative of exceptions that occur when certain instructions are executed within a processor core. For example, if an ADD operation performed by an execution unit (EU) within a processor core attempts to add two operands such that an overflow results (i.e., the sum is a value that is larger than a capacity of a target register in which the sum is to be stored), then a floating-point overflow exception bit (OX) is stored within the FPSCR. Subsequent operations/instructions within a software thread will need to know about and/or use this exception bit. When stored within the FPSCR, such exception bits are called “sticky bits” if they are non-transitory (i.e., they can only be cleared out of the FPSCR by a move-to-FPSCR instruction), such that the sticky bits are changed/flushed from the FPSCR.

Fast execution of reads (i.e., moving a sticky bit from the FPSCR) and clears (i.e., moving a sticky bit to the FPSCR) is highly important to a floating point code's performance. That is, when the FPSCR's sticky bit is updated by a floating point execution unit (e.g., a floating point add execution unit, a floating point load execution unit, etc.), all subsequent instructions that required the sticky bit must wait for the bit to be set before they can be executed. If the instructions are executed in order (i.e., in a serial next-to-complete (NTC) manner), then performance can suffer. That is, operations are slowed down since only one execution unit can be used at a time, and since no instruction can execute until the preceding instruction in the software thread executes, even if the subsequent instruction does not depend on the preceding instruction. However, if instructions are executed out of order (OOO), then problems may arise if an instruction reads the FPSCR looking for a sticky bit that should have been provided by a previous instruction, but which is not there since the OOO instruction was executed before that previous instruction (that generated and stored the sticky bit in the FPSCR) was executed.

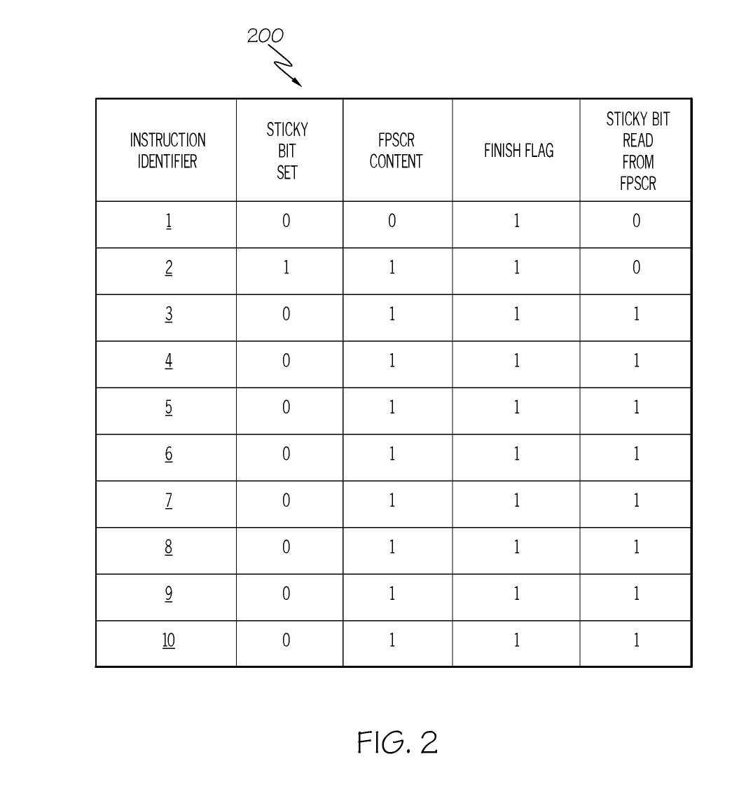

FIG. 2 illustrates a table 200 showing the impact on sticky bits within a floating-point status and control register (FPSCR) in a processor core when instructions within a software thread are executed in a next-to-complete (NTC) serial manner. Assume that instructions 1-10 identified in the “Instruction identifier” column are instructions in a software thread (i.e., a set of instructions designed to be executed as a set). Assume further in FIG. 2 that instructions 1-10 are executed in an NTC in-order (serial) manner. That is, instruction 2 waits until instruction 1 finishes executing (i.e., being dispatched to a particular hardware execution unit in the processor core such as a floating point addition hardware execution unit, a floating point load/store hardware execution unit, etc.) before instruction 2 executes. Similarly, instruction 3 waits until instruction 2 finishes executing before instruction 3 starts executing, instruction 4 waits until instruction 3 finishes executing before instruction 4 starts executing, etc.

Assume now that instruction 1 is not able to set a sticky bit (as indicated by the “0” in the “Sticky bit set” column) for a particular exception condition (e.g., a data overflow). Thus, the content of the FPSCR for this exception/sticky bit is empty (as indicated by the “0” in the “FPSCR content” column) after instruction 1 executes (as indicated by the “1” in the “Completion flag” column). Note that since there is no earlier instruction in the software thread (instructions 1-10), then there is no sticky bit in the FPSCR (for this exception) for instruction 1 to read (assuming that the FPSCR is flushed before a new software thread starts executing).

With reference now to instruction 2, assume that instruction 2 is able to set the sticky bit (as indicated by the “1” in the “Sticky bit set” column), and does so (as indicated by the “1” in the FPSCR content column) after it finishes executing (as indicated by the “1” in the “completion flag” column). Note that instruction 1 did not set the sticky bit, and thus there is no sticky bit in the FPSCR for instruction 2 to read (as indicated by the “0” in the “Sticky bit read from FPSCR” column).

With reference now to instruction 3, note that instruction 3 reads the sticky bit from the FPSCR (as indicated by the “1” in the “Sticky bit read from FPSCR” column) that was set by instruction 2. Similarly, instructions 4-10 also read this same sticky bit that was set by instruction 2, since the exception/sticky bit remains in the FPSCR (i.e., is “sticky”). Thus, each of instructions 3-10 read the correct sticky/set/exception bit.

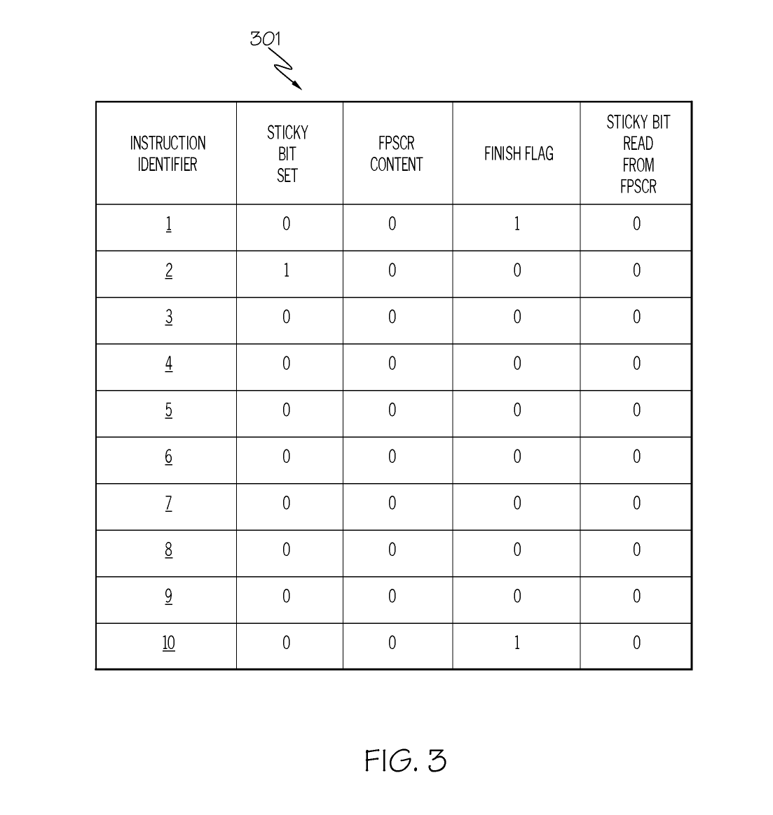

With reference now to FIG. 3, a table 301 shows the same instructions 1-10, but now they are able to execute out of order (OOO). For example, assume that instruction 1 has executed (as indicated by the “1” in the “Finish flag” column), and then instruction 10 executes out of order (as indicated by the “1” in the “Finish flag” column for instruction 10 but where there is a “0” in the “Finish flag” column for instructions 2-9). When instruction 10 executes, there is no exception/sticky bit (for the exception described above) in the FPSCR, since instruction 2 has not executed yet. Thus, instruction 10 will erroneously assume that there is no exception/sticky bit in the FPSCR, and will not execute properly. Note that the term “Finish” indicates that the instruction has executed and written back results, which can happen out of order.

Thus, the present invention presents a new and novel mechanism to provide out-of-order execution of instructions that use the FPSCR's sticky bit to improve performance of the processor core. That is, the software thread (instructions 1-10) could always execute serially (in a next-to-complete mode), but this is slow and inefficient. Therefore, out-of-order (OOO) instruction execution is faster if the sticky bits have been set at the right time. The present invention allows the processor core to routinely execute instructions in the software thread out-of-order, and to revert to the slower NTC serial mode only when there is an error in the FPSCR sticky bit (i.e., it has not been timely set).

With reference now to FIG. 4, illustrative components (i.e., not all of the components) within a processor core 400 that enable the management of sticky bits within an FPSCR when instructions within a software thread are executed out of order within the processor core is presented. That is, the present invention allows for speculative OOO instruction execution that assumes that sticky bits in the FPSCR are correct (i.e., they have been timely changed or else they do not change at all) while execution of instructions in a software thread are in flight (i.e., are in the process of executing within the processor core). However, if a sticky bit changes, then the thread is flushed as described below (i.e., beginning with the next instruction that is identified as being able to read or clear the sticky bit), and the process switches to a serial (NTC) execution order.

Note that the FPSCR 428 (e.g., an architected FPSCR) depicted in FIG. 4 may be accessed by the mapper/register file 406, the completion logic 418, the FPSCR-sticky flip detection 414, and other components of the processor core 400 shown in FIG. 4.

As shown within processor core 400, a dispatch 402 is a hardware dispatching device that dispatches instructions to an instruction sequencing unit (ISU) 432 (i.e., elements below line 404 in FIG. 4). Dispatch 402 dispatches instructions (e.g., instructions 1-10 shown in FIG. 3) and identifies them according to whether or not they are able to set sticky bits (see the “Sticky bit set” columns in FIG. 3). That is, table 301 in FIG. 3 is (or includes) an instruction completion table (ICT) that identifies which instructions are able to read (read a sticky bit from the FPSCR) or clear (move a zero to the FPSCR) sticky bits as “FPSCR-sticky instructions”. Table 301 also indicated a “FPSCR-sticky-pending” bit per thread to indicate that a sticky bit may change during the course of execution according to a particular instruction (e.g., instruction 2 in FIG. 3). This bit is active only when the ICT includes any FPSCR-sticky-instruction.

A Mapper/Register file 406 includes a hardware mapper that sources out the architected sticky bit to instructions that need to use it as a source, and also indicates to the Issue Queue 408 that the source (i.e., operand source such as a data cache in the processor core or result of an arithmetic instruction), is ready (i.e., has the requisite instruction code and operand data).

As described herein, the Mapper/Register file 406 generates a “sticky-change” bit per thread when an architected sticky-bit is modified (see FIG. 3).

Issue queue 408 is a hardware storage device that stores an FPSCR-sticky source (i.e., the source data, or at least a tag indicating which instructions will produce the source data). The “valid” column in issue queue 408 indicates whether or not a particular instruction has an FPSCR-sticky source (i.e., needs to read the FPSCR).

If the instruction is using the FPSCR sticky bit as a source (when a speculative out-of-order execution is being performed), then the instruction is executed normally and out-of-order. Similarly, if the instruction is known to actually set or clear the sticky bit, then it is issued out normally, even if out-of-order.

Execution unit 410 represents one or more hardware execution units within the processor core. Examples of execution unit 410 include, but are not limited to, floating-point addition hardware units, floating-point load/store hardware units, etc., as well as sticky bit setters, sticky bit handlers, etc. As indicated by line 412, some instructions cause execution unit 410 to directly (and always) set a sticky (exception) bit into the FPSCR, such as “Move To (MT) the FPSCR” instruction. Other instructions such as an “ADD” instruction may or may not set a sticky bit into the FPSCR, as also indicated by line 412.

If the instruction using the FPSCR sticky bit is executing, then it executes and may write the sticky bit back as normal. Similarly, if the instruction setting the FPSCR sticky bit is executing, then it also executes and writes the sticky bit back as normal. If the sticky-bit changes, a FPSCR-sticky flip detection 414 (e.g., a hardware device that detects the change to the sticky bit) tells the Mapper/Register file 406 that a sticky bit is flipping. The Mapper/Register file 406 will then generate a “sticky change” bit and send it to the exception logic 416 as discussed below.

Completion logic 418 maintains an instruction completion table (ICT), which is a record of all instructions in flight, with an indicator for instructions that are able to set a sticky bit (as identified in the column labeled “FPSCR-sticky”). The “Valid” column indicates whether or not a particular instruction has completed (invalid) or is still in flight (valid—waiting to complete or else in the process of completing). When the FPSCR-sticky-bit instruction is at NTC (i.e., is the next to complete instruction, even though the software thread is executing in an out-of-order manner), then the processor core stops the completion logic 418 from completing instructions until the exception logic 416 is given the opportunity to examine the sticky-bit status.

With reference again to the exception logic 416, a “FPSCR-change-seen” bit per thread as received from the Mapper/Register File 406 is maintained by 1) setting the “FPSCR-change-seen” bit when a “sticky-change” occurs (as detected by the FPSCR-sticky flip detection 414), and 2) clearing the “FPSCR-change-seen” bit when “FPSCR-sticky-pending” is not active.

When an instruction completion table (ICT) (i.e., hardware that is in the ISU) is stopped for an FPSCR-sticky bit, the ICT examines the “FPSCR-change-seen” bit. If the “FPSCR-change-seen” bit is set, then a NTC FPSCR flush is performed, thus clearing the “FPSCR-change-seen” bit and setting a corresponding “FPSCR-flush” bit. For example, assume that instruction 2 in FIG. 3 is the first instruction that is able to read or clear the sticky bit. As such, all instructions beginning with instruction 2 (include the NTC instruction 2 and subsequent instructions 3-10) are flushed (including their sticky bits). These operations are performed by the FPSCR sticky change processing 420, which identifies at least one of the instructions in the completion logic 418 is able to flip the sticky bit (according to OR logic 422).

A Back-off Mechanism (i.e., logic above line 404 in FIG. 4) allows the processor core to switch from out-of-order (OOO) instruction execution to next-to-complete (NTC) instruction execution based on the change to the sticky bit. Thus, the “Back-off” mechanism includes a backoff counter 424 (that identifies how many FPSCR sticky-reading or -clearing instructions after the FPSCR flush instruction are to be executed when NTC) and a decoder 426 (that lets the dispatch 402 know if an instruction is an FPSCR-sticky bit reader or clearer and/or if the instructions should now be executed serially in a NTC manner) handles this by forcing any FPSCR sticky-reading or -clearing instructions to be marked as “NTC issue” during a window after an FPSCR flush.

The Decoder “Back-off” Behavior affects certain operations, such as those operations that can clear sticky FPSCR exceptions and those operations that read sticky FPSCR exceptions.

The backoff counter 424 sets a new counter to be implemented per thread. The backoff counter 424 is active when non-zero. The backoff counter 424 is set to a maximum value (e.g., 8 instructions after the identified sticky bit setting instruction) that are marked as “NTC Issue” when “FPSCR-flush” occurs. The backoff counter 424 is also set to the maximum value when the when counter is non-zero and “FPSCR-change-seen” occurs.

With reference now to FIG. 5, a high-level flow chart of exemplary steps taken by hardware devices to manage sticky bits within an FPSCR when instructions within a software thread are executed out of order within a processor core is presented.

After initiator block 501, a hardware execution unit (e.g., execution unit 410 shown in FIG. 4) within a processor core (e.g., processor core 400 shown in FIG. 4) executes a second instruction, as described in block 503. The second instruction (e.g., instruction 10 in FIG. 3) is part of a software thread, and is executed out of order within the software thread (e.g., before instruction 2).

A sticky bit flip detection hardware device (e.g., FPSCR-sticky flip detection 414 shown in FIG. 4) detects a change to a sticky bit in a floating-point status and control register (e.g., FPSCR 428 shown in FIG. 4) within the processor core, as described in block 505. The sticky bit is an exception bit that describes an exception that has occurred while executing an instruction within the processor core, and remains fixed until cleared by a Move-To FPSCR instruction.

As described in block 507, an issue queue (e.g., issue queue 408 in FIG. 4) identifies a first instruction (e.g., instruction 2 in FIG. 3) in the software thread that is capable of setting the sticky bit. As described in the examples presented herein, the first instruction is sequentially listed before any other instruction in the software thread that is capable of setting the sticky bit. That is in FIG. 3, instruction 1 is not able to set the sticky bit; thus instruction 2 is the first instruction in the software thread that is capable of setting a sticky bit.

As described in block 509, in response to examining that the next-to-complete instruction has been identified as an FPSCR-sticky bit reader or clearer, a flushing execution unit (e.g., FPSCR sticky change processing 420 and dispatch 402 shown in FIG. 4) flushes all results of instructions from an instruction completion table (ICT) that include and are after the next-to-complete instruction in the software thread.

As described in block 511, in response to the flushing execution unit flushing all results of instructions from the ICT that include and are after the first instruction in the software thread, a hardware dispatch device (e.g., dispatch 402 in FIG. 4) dispatches all instructions beginning with the first instruction in the software thread for execution by one or more hardware execution units within the processor core in a next-to-complete (NTC) sequential order, for those instructions that can read or clear FPSCR sticky bits. Thus, instructions 3-10 in FIG. 3 that can read or clear FPSCR sticky bits are now relegated to executing sequentially in a NTC manner.

The flow-chart ends at terminator block 513.

In an embodiment of the present invention, an ICT stop bit setter (e.g., ICT stop bit setter 430 in FIG. 4) sets an ICT stop bit in the ICT (e.g., in the issue queue 408) to identify all instructions that are capable of reading or clearing the sticky bit.

In an embodiment of the present invention, the hardware dispatch device (e.g., backoff counter 424 and dispatch 402 in FIG. 4) limits the instructions that can read or clear FPSCR sticky bits, beginning with the FSPCR-flushed instruction being executed in the NTC sequential order.

In an embodiment of the present invention, the first instruction is a move to instruction to write a sticky bit directly into the FPSCR.

In an embodiment of the present invention, the first instruction is a floating point instruction whose execution results in the sticky bit being set in the FPSCR.

In an embodiment of the present invention, a sticky bit flag hardware setter (e.g., part of mapper/register file 406 shown in FIG. 4) sets a flag with the ICT that identifies all instructions that are capable of reading or clearing a sticky bit from the FPSCR.

In an embodiment of the present invention, the first instruction and the second instruction are floating point instructions.

Note that the flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A method comprising:
executing, by a hardware execution unit within a processor core, a second instruction, wherein the second instruction is part of a software thread, and wherein the second instruction is executed out of order within the software thread;
detecting, by a sticky bit flip detection hardware device, a change to a sticky bit in a floating-point status and control register (FPSCR) within the processor core, wherein the sticky bit is an exception bit that describes an exception that has occurred while executing an instruction within the processor core, and wherein the sticky bit remains fixed until cleared by a move-to-FPSCR instruction;
identifying, by an instruction issue hardware unit, a first instruction in the software thread that is capable of reading or clearing the sticky bit, wherein the first instruction is sequentially listed before any other instruction in the software thread that is capable of reading or clearing the sticky bit;
in response to the instruction issue hardware unit identifying the first instruction, flushing, by a flushing execution unit, all results of instructions from an instruction completion table (ICT) that include and are after the first instruction in the software thread; and
in response to the flushing execution unit flushing all results of instructions from the ICT that include and are after the first instruction in the software thread, dispatching, by a hardware dispatch device, all instructions that include and are after the first instruction in the software thread and that are capable of reading or clearing a sticky bit, for execution by one or more hardware execution units within the processor core in a next-to-complete (NTC) sequential order.

2. The method of claim 1, further comprising:
setting, by an ICT stop bit setter, an ICT stop bit in the ICT to identify all instructions that are capable of reading or clearing the sticky bit.

3. The method of claim 1, further comprising:
limiting, by the hardware dispatch device, the instructions that can read or clear FPSCR sticky bits, beginning with an FPSCR-flushed instruction being executed in the NTC sequential order.

4. The method of claim 1, wherein the first instruction is a move to instruction to write a sticky bit directly into the FPSCR.

5. The method of claim 1, wherein the first instruction is a floating point instruction whose execution results in the sticky bit being set in the FPSCR.

6. The method of claim 1, further comprising:
setting, by a sticky bit flag hardware setter, a flag within the ICT that identifies all instructions that are capable of reading or clearing the sticky bit from the FPSCR.

7. The method of claim 1, wherein the first instruction and the second instruction are floating point instructions.

8. A computer program product comprising one or more computer readable storage mediums, and program instructions loaded on at least one of the one or more storage mediums, the loaded program instructions comprising:
program instructions to execute a second instruction, wherein the second instruction is part of a software thread, and wherein the second instruction is executed out of order within the software thread;
program instructions to detect a change to a sticky bit in a floating-point status and control register (FPSCR) within the processor core, wherein the sticky bit is an exception bit that describes an exception that has occurred while executing an instruction within the processor core, and wherein the sticky bit remains fixed until cleared by a move-to-FPSCR instruction;
program instructions to identify a first instruction in the software thread that is capable of reading or clearing the sticky bit, wherein the first instruction is sequentially listed before any other instruction in the software thread that is capable of reading or clearing the sticky bit;
program instructions to, in response to identifying the first instruction, flush all results of instructions from an instruction completion table (ICT) that include and are after the first instruction in the software thread; and
program instructions to, in response to flushing all results of instructions from the ICT that include and are after the first instruction in the software thread, dispatch all instructions that include and are after the first instruction in the software thread and that are capable of reading or clearing a sticky bit, for execution by one or more hardware execution units within the processor core in a next-to-complete (NTC) sequential order.

9. The computer program product of claim 8, further comprising:
program instructions to set an ICT stop bit in the ICT to identify all instructions that are capable of reading or clearing the sticky bit.

10. The computer program product of claim 8, further comprising:
program instructions to limit the instructions that can read or clear FPSCR sticky bits, beginning with an FPSCR-flushed instruction being executed in the NTC sequential order.

11. The computer program product of claim 8, wherein the first instruction is a move to instruction to write a sticky bit directly into the FPSCR.

12. The computer program product of claim 8, wherein the first instruction is a floating point instruction whose execution results in the sticky bit being set in the FPSCR.

13. The computer program product of claim 8, further comprising:
program instructions to set a flag within the ICT that identifies all instructions that are capable of reading or clearing the sticky bit from the FPSCR.

14. The computer program product of claim 8, wherein the first instruction and the second instruction are floating point instructions.

15. A processor core comprising:
a hardware execution unit within a processor core, wherein the hardware execution unit executes a second instruction, wherein the second instruction is part of a software thread, and wherein the second instruction is executed out of order within the software thread;
a sticky bit flip detection hardware device that detects a change to a sticky bit in a floating-point status and control register (FPSCR) within the processor core, wherein the sticky bit is an exception bit that describes an exception that has occurred while executing an instruction within the processor core, and wherein the sticky bit remains fixed until cleared by a move-to-FPSCR instruction;
an instruction issue hardware unit that identifies a first instruction in the software thread that is capable of reading or clearing the sticky bit, wherein the first instruction is sequentially listed before any other instruction in the software thread that is capable of reading or clearing the sticky bit;
a flushing execution unit that, in response to the first instruction being identified in the issue queue, flushes all results of instructions from an instruction completion table (ICT) that include and are after the first instruction in the software thread; and
a hardware dispatch unit that, in response to the flushing execution unit flushing all results of instructions from the ICT that include and are after the first instruction in the software thread, dispatches all instructions that include and are after the first instruction in the software thread and that are capable of reading or clearing a sticky bit, for execution by one or more hardware execution units within the processor core in a next-to-complete (NTC) sequential order.

16. The processor core of claim 15, further comprising:
an ICT stop bit setter that sets an ICT stop bit in the ICT to identify all instructions that are capable of reading or clearing the sticky bit.

17. The processor core of claim 15, wherein the hardware dispatch device limits the instructions that can read or clear FPSCR sticky bits, beginning with an FPSCR-flushed instruction being executed in the NTC sequential order.

18. The processor core of claim 15, wherein the first instruction is a move to instruction to write a sticky bit directly into the FPSCR.

19. The processor core of claim 15, wherein the first instruction is a floating point instruction whose execution results in the sticky bit being set in the FPSCR.

20. The processor core of claim 15, further comprising:
a sticky bit flag hardware setter for setting a flag within the ICT that identifies all instructions that are capable of reading or clearing the sticky bit from the FPSCR.
